(19) United States
(12) Patent Application Publication
(10) Pub. No.: US 2012/0066920 A1
(43) Pub. Date: Mar. 22, 2012

(54) AUTOLEVELING METHODS, DEVICES AND SYSTEMS

(75) Inventors: Paul Stangl, West Bend, WI (US); Ken Seidl, Port Washington, WI (US); Ed Nowak, West Bend, WI (US)

(73) Assignee: RAFFEL SYSTEMS, LLC, Germantown, WI (US)

(21) Appl. No.: 12/886,219

(22) Filed: Sep. 20, 2010

(51) Int. Cl. G01C 9/06; G06F 19/00; G01C 9/00

(52) U.S. Cl. 33/366.11; 702/154

(57) ABSTRACT

The invention provides methods, devices, and systems for autoleveling of an apparatus. In particular, the invention provides devices and systems for autoleveling support apparatuses, such as hospital-type beds, and methods of use thereof.

### FIELD OF THE INVENTION

The invention provides methods, devices, and systems for autoleveling of an apparatus. In particular, the invention provides devices and systems for autoleveling support apparatuses, such as hospital-type beds, and methods of use thereof.

### BACKGROUND

Hospital beds typically contain mechanical and electronic components for movement, functionality and convenience. Generally, a bed is moved by a series of internal motors or actuators and controlled by means of an interface that can be accessed by users, such as hospital personnel or the patient, to adjust the bed to suit the treatment and comfort needs of the patient. For example, a hospital or nursing home bed may incorporate a number of linear actuators to allow the patient or care giver to raise, lower, tilt, reposition, and/or move the bed. However, due to unequal loads and/or inherent inaccuracies in the lifting mechanism, beds commonly do not come to rest in a level or desired position (e.g., relative to the floor or a user defined reference). Misalignment of the hospital beds can result in discomfort for the patient, difficult access to the patient for care givers, and compromised patient care.

### SUMMARY OF THE INVENTION

In some embodiments, the invention provides a device comprising a position feedback device, processor, and integration circuitry configured for integration with control circuitry of a support apparatus; wherein the device detects deviations in position of the support apparatus and directs a lift mechanism of the support apparatus to correct a deviation. In some embodiments, the position feedback device comprises an inclinometer. In some embodiments, the inclinometer comprises a digital inclinometer. In some embodiments, the position feedback device comprises an accelerometer. In some embodiments, the integration circuitry is configured for universal integration into control circuitry of a support apparatus. In some embodiments, the universal integration comprises use of one or more integration adapters. In some embodiments, the lift mechanism comprises one or more (e.g., two, three, four or more) actuators. In some embodiments, the device is integrated into the control circuitry between the control unit and lift mechanism of the support apparatus. In some embodiments, deviations in the position of the support apparatus comprises deviations in incline of the support apparatus. In some embodiments, deviations in incline comprise deviations between a measured incline and a reference incline. In some embodiments, the measured incline is measured by the position feedback device. In some embodiments, the reference incline is set based on an absolute reference incline, instructions from the support apparatus, or user input. In some embodiments, the device directs the lift mechanism to correct the incline of the support apparatus when the deviation incline exceeds an acceptable threshold of deviation. In some embodiments, an acceptable threshold of deviation comprises 1°-10° (e.g. 1°, 2°, 3°, 4°, 5°, 6°, 7°, 8°, 9°, 10°, and values therein). In some embodiments, an acceptable threshold of deviation comprises about 1° (e.g. 1°). In some embodiments, an acceptable threshold of deviation comprises 2° (e.g. 2°). In some embodiments, an acceptable threshold of deviation comprises 3° (e.g. 3°). In some embodiments, an acceptable threshold of deviation comprises 4° (e.g. 4°). In some embodiments, an acceptable threshold of deviation comprises 5° (e.g. 5°).

In some embodiments, the invention provides a method of autoleveling a support apparatus comprising: (a) providing: (i) a support apparatus, wherein the support apparatus comprises: (A) a support surface; (B) a position adjustment system comprising: two or more actuator-driven lift mechanisms, control unit, and control circuitry connecting the control unit to the actuator driven lift mechanisms; and (ii) an autoleveling device, wherein the autoleveling device comprises an inclinometer, processor, and integration circuitry; (b) attaching the autoleveling device to the support apparatus, wherein the inclinometer detects the degree of inclination of the support surface;(c) integrating the integration circuitry of the autoleveling device into the control circuitry of the support apparatus; (d) detecting the degree of inclination of the support surface of the support apparatus; (e) comparing the detected degree of inclination of the support surface to a reference inclination; and (f) providing means for directing the position adjustment system, wherein such means adjusts the height of one or more actuator-driven lift mechanisms to correct any deviation between the detected degree of inclination and the reference inclination. In some embodiments, the means directs the position adjustment system according to FIG. 5. In some embodiments, the reference inclination is set manually by a user by engaging a level-set element when the support surface is at the reference inclination. In some embodiments, the level set element comprises a level-set button. In some embodiments, the reference inclination is set manually by a user by depressing the level-set button. In some embodiments, following user-initiated adjustment of the inclination of the support surface, the reference inclination is automatically set to the newly achieved incline. In some embodiments, the reference inclination is based on an absolute inclination. In some embodiments, the absolute inclination is aligned with the force of gravity. In some embodiments, the reference inclination for the support surface is offset by an angle with respect to the absolute inclination. In some embodiments, the reference inclination for the support surface is perpendicular to the absolute inclination. In some embodiments, the offset of the reference inclination with respect to the absolute inclination is set by the level-set button on the autoleveling device. In some embodiments, the offset of the reference inclination with respect to the absolute inclination is set upon user-initiated adjustment of the inclination of the support surface. In some embodiments, steps (d)-(f) are performed following a user-initiated change in the height of the support surface. In some embodiments, steps (d)-(f) are performed following a user-initiated increase in the height of the support surface. In some embodiments, steps (d)-(e) are performed continuously. In some embodiments, step (f) is performed when a deviation is detected between the detected degree of inclination and the reference inclination. In some embodiments, the steps (d)-(e) are performed periodically. In some embodiments, periodically comprises at least every 10 minutes. In some embodiments, periodically comprises as frequently as every 1 second. In some embodiments, step (f) is performed when a deviation is detected between the detected degree of inclination and the reference inclination. In some embodiments, steps (d)-(f) are not performed following a user-initiated decrease in the height of the support surface. In some embodiments, steps (d)-(f) are performed following a change in the mass or distribution of the load on the support apparatus.

In some embodiments, the invention provides a method of retrofitting a support apparatus with autoleveling functionality comprising: (a) providing: (i) a support apparatus, wherein the support apparatus comprises: (A) a support surface; (B) a position adjustment system comprising: two or more actuator-driven lift mechanisms, control unit, and control circuitry connecting the control unit to the actuator driven lift mechanisms; and (ii) an autoleveling device, wherein the autoleveling device comprises an inclinometer, processor, and integration circuitry; (b) attaching the autoleveling device to the support apparatus; (c) integrating the integration circuitry of the autoleveling device into the control circuitry of the support apparatus, thereby integrating the autoleveling device into the position adjustment system of the support apparatus, wherein the processor of the integrated autoleveling device is configured to: (i) receive control instructions from the control unit to the actuator-driven lift mechanisms; (ii) set a reference inclination based on the control instructions, user input, and/or an absolute reference; (iii) detect degree of inclination of the support surface of the support apparatus; (iii) compare the detected degree of inclination of the support surface to the reference inclination; and (iv) direct the position adjustment system to adjust the height of one or more actuator-driven lift mechanisms to correct any deviation between the detected degree of inclination and the reference inclination.

In some embodiments, the invention provides a method of retrofitting a support apparatus with autoleveling functionality comprising: (a) providing: (i) a support apparatus, wherein the support apparatus comprises: (A) a support surface; (B) a position adjustment system comprising: an actuator-driven lift mechanism (e.g. one, two, three, four five, six, seven, eight, nine, ten, etc. actuator-driven lift mechanisms), control unit, and control circuitry connecting the control unit to the actuator driven lift mechanisms; and (ii) an autoleveling device, wherein the autoleveling device comprises an inclinometer, processor, and integration circuitry; (b) attaching the autoleveling device to the support apparatus; (c) integrating the integration circuitry of the autoleveling device into the control circuitry of the support apparatus, thereby integrating the autoleveling device into the position adjustment system of the support apparatus, wherein the processor of the integrated autoleveling device is configured to: (i) receive control instructions from the control unit to the actuator-driven lift mechanisms; (ii) set a reference inclination based on the control instructions, user input, and/or an absolute reference; (iii) detect degree of inclination of the support surface of the support apparatus; (iii) compare the detected degree of inclination of the support surface to the reference inclination; and (iv) direct the position adjustment system to adjust the height of an actuator-driven lift mechanism to correct any deviation between the detected degree of inclination and the reference inclination. In some embodiments, an actuator-driven lift mechanism comprises a scissors lift mechanism.

### BRIEF DESCRIPTION OF THE FIGURES

The following drawings form part of the present specification and are included to further illustrate aspects of the invention. The drawings highlight exemplary embodiments of the invention, but should not be viewed as limiting the scope of the invention. The invention may be better understood by reference to the drawings in combination with the detailed description of the specific embodiments presented herein.

FIG. 1 shows an image of an exemplary autoleveling device of the invention.

FIG. 2 shows an image of an exemplary autoleveling device attached to a hospital bed.

FIG. 3 shows an image of a connection of a 13-Pin din of an autoleveling device to a Y-cord of a hospital bed.

FIG. 4 shows an image depicting the level-set button and level indicator LEDs of an exemplary autoleveling device.

FIG. 5 shows a flow chart depicting logic flow for a main microprocessor of an autoleveling device.

FIG. 6 shows a flowchart depicting logic flow for a microprocessor directing reading, filtering, storing, and display of an incline value.

FIG. 7 shows a flowchart depicting the logic flow for a microprocessor timer interrupt.

FIG. 8 shows a flowchart depicting the logic flow for a microprocessor of an autoleveling device configured for left/right autoleveling.

### DEFINITIONS

As used herein, the terms “hospital bed” or “hospital-type bed” refer to any bed, cot, support apparatus or positioning apparatus fitted with power driven height- and/or configuration-adjustment means (e.g., mechanical actuator, hydraulic actuator, etc.). Typically, the adjustment means allow a subject in the “hospital bed” or a person (e.g., health care provider, care giver, etc.) assisting a subject in the “hospital bed” to adjust the height of the bed, or to reconfigure the “hospital bed” by raising or lowering a portion of the bed (e.g., raise the foot portion of the bed, raise the head portion of the bed, tilt bed, etc.). Unless otherwise specified, embodiments described herein referring to the term “hospital bed” are also applicable to other beds, cots, position apparatuses, and/or support devices.

As used herein, the terms “patient” or “subject” refer to an occupant or the individual lying in/on, sitting in/on, or standing in/on a hospital bed or support apparatus of the invention. A “patient” or “subject” may utilize controls to raise, lower, and/or position the hospital bed or support apparatus, or may have position and height adjustments made by 3^{rd} party operator (e.g., caregiver, clinician, family member, etc.).

As used herein, the term “user” or “operator” refers to an individual who utilizes controls on a hospital bed or support apparatus to manipulate or adjust the position and/or height. In some embodiments, the “user” is a patient or subject occupying the hospital bed or support apparatus. In some embodiments, the “user” or “operator” does not occupy bed or apparatus (e.g., caregiver, lift operator, etc.).

As used herein, the term “autoleveling” refers to the process of correcting the incline of an apparatus with respect to an absolute reference or a defined reference, without manual or affirmative intervention to achieve such leveling. “Autoleveling” may occur following user-induced mechanical alteration of the height or incline of an apparatus, or may occur automatically upon detection of the apparatus becoming unlevel.

As used herein, the term “unlevel” refers to a state of incline of an apparatus or surface in which the incline is greater than a threshold deviation from that of an absolute reference (e.g., pull of gravity) or a defined reference (e.g., ground surface, user-defined slope). An autoleveling device will typically act to correct a surface deemed to be “unlevel.” A threshold of allowable deviation may be inherent to an autoleveling device (e.g., pre-programmed) or may be defined by a user or operator, and may be as great as ±5°, as small as ±0.01°, or any threshold there between.

As used herein, the term “level” refers to a surface or apparatus within a given threshold of allowable deviation from an absolute reference (e.g., pull of gravity) or a defined reference (e.g., ground surface, user-defined slope). A threshold of allowable deviation may be <5°, <2°, <1°, <0.5°, <0.2°, <0.1°, <0.05°, <0.02°, <0.01°, etc. from a reference slope. A “level surface may be one that has been corrected by autoleveling (e.g., by an autoleveling device) to be within the allowable threshold, or may simply reside within the threshold.

As used herein, the term “incline” refers to the degree of deviation of a surface, object, or apparatus from a reference. If not otherwise specified, “incline” refers to the degree of deviation from horizontal, parallel to the earth's surface, and/or perpendicular to the force of gravity. The degree of incline can be measured from any defined or selected reference slope (e.g., 0-90° with respect to horizontal). An apparatus comprising freely movable sections may adopt several different “inclines” along its length. For example, and adjustable hospital bed may adopt one “incline” for the upper body portion and a distinct incline for the lower body portion.

As used herein, the term “position” refers to the overall conformation of a surface, object, or apparatus. The “position” accounts for the inclines of various portions of an apparatus or surface comprising freely movable sections. A set of inclines for the various sections, portions, or segments describe the “position” of a surface, object, or apparatus. The “position” of an apparatus may be described in any suitably descriptive manner for example, in terms of the inclines of the various segments (e.g., lower portion 0° from horizontal, upper portion +35° from horizontal). “Position” descriptions may also include qualitative descriptions (e.g., lithotomy position, Trendelenburg, reverse Trendelenburg, Fowler, semi-Fowler, etc.). For example, a hospital bed position could be described as “Trendelenburg with the upper portion horizontal and the lower portion +20° from horizontal.”

As used herein, the terms “head” and “foot” describe opposing ends of an object, apparatus, or surface (e.g., a bed). If the object, apparatus, or surface is configured to support a human subject, the “head” and “foot” ends may have an inherently defined orientation. When a “head” and “foot” is not inherent to the design of the object, apparatus, or surface, they may be arbitrarily assigned. An object, apparatus, or surface may have a “head” and/or “foot” without being designed for supporting a human subject.

As used herein, the term “housing” refers to the structure encasing or enclosing at least one component (e.g., inclinometer) of the devices of the invention.

As used herein, the term “computer readable medium” refers to any device or system for storing and providing information (e.g., data and instructions) to a computer processor. Examples of computer readable media include, but are not limited to, DVDs, CDs, hard disk drives, magnetic tape, flash memory, and servers for streaming media over networks.

As used herein, the term “transmitting” refers to the movement of information (e.g., data) from one location to another (e.g., from one device to another) using any suitable means.

### DETAILED DESCRIPTION OF THE INVENTION

The invention provides methods, devices, and systems for autoleveling of an apparatus. In particular, the invention provides devices and systems for autoleveling patient support apparatuses, such as hospital-type beds, and methods of use thereof. In some embodiments, the invention provides autoleveling devices to prevent the unleveling support apparatuses (e.g., hospital bed) following height adjustment and/or change in the mass or distribution of a load. In some embodiments, the invention provides support apparatuses (e.g., hospital beds) utilizing a position feedback device (e.g., inclinometer) that integrates with the adjustment means (e.g., motor, actuator, etc.) and/or control means (e.g., control panel, control wand, control circuitry, etc.) to automatically position the apparatus at a user defined position, or at a defined angle relative to the ground (e.g., parallel to the ground) or gravity (e.g., perpendicular to the force of gravity). In some embodiments, the invention provides autoleveling devices to prevent uneven rise (e.g., caused by uneven load, disparity in speed or strength of lift mechanisms, etc.) of a support apparatus (e.g., hospital bed).

In some embodiments, the invention provides devices comprising one or more position feedback devices (e.g., inclinometers, accelerometers, etc.), capable of integrating with a support apparatus (e.g., hospital bed), or the control and/or adjustment means thereof, to automatically position the apparatus at a user defined position, or at a defined angle relative to the ground (e.g., parallel to the ground) or gravity (e.g., perpendicular to the force of gravity). In some embodiments, the invention provides an independent device (e.g., separate from the support apparatus) which integrates with a support apparatus, or a lift mechanism and/or control unit thereof, to autolevel the support apparatus. In some embodiments, the invention provides an independent device which integrates with a support apparatus, and/or a lift mechanism or control unit therewith, to correct (e.g., make level) the support apparatus following height or position adjustment or an unleveling event (e.g., load redistribution). In some embodiments, an autoleveling device of the invention integrates with a support apparatus, or a lift mechanism and/or control unit therewith, but is a separate functioning device from the support apparatus.

In some embodiments, autoleveling devices and/or systems detect the position and/or incline of a support apparatus (e.g., relative to the ground, gravity, or a user defined position). In some embodiments, the invention detects, measures, and/or quantifies the slope, incline, and or position of a support apparatus. In some embodiments, the invention detects the absolute position of a device or apparatus. In some embodiments, the invention detects the absolute incline of a device or apparatus (e.g., incline with respect to the pull of gravity). In some embodiments, the invention detects the position and/or incline of a device or apparatus relative to a defined reference (e.g., a desired/selected slope and/or position) or absolute reference (e.g., gravity). In some embodiments, devices and systems detect the position of a support apparatus (e.g., hospital bed) and compare the detected position to a reference and/or selected position. In some embodiments, devices and systems detect the incline of a support apparatus (e.g., hospital bed) and compare the detected incline to a reference and/or selected incline. In some embodiments, devices and systems do not rely on measurements of the position of actuators, mechanical devices, legs, supports, etc. In some embodiments, devices and systems of the invention do not operate via mechanical feedback loops. In some embodiments, devices and systems of the invention detect the incline and/or position of a surface, apparatus, or object in space, and do not measure the position (e.g., degree of extension) of components (e.g., actuators, legs, etc.) of the surface, apparatus, or object.

In some embodiments, a device or system of the invention is configured to integrate with a hospital bed. An exemplary hospital bed which finds use in the invention comprises one or more adjustment means (e.g. two or more adjustment means) and/or mechanical lift devices (e.g., linear actuators, hydraulic cylinders, electric motors, etc.) for raising and lowering all or a portion of the bed. In some embodiments, one or more mechanical lift devices are configured to raise and/or lower each of the movable surfaces, sections, segments, and/or portions (e.g., head, foot, lumbar, thigh, etc.) of a hospital bed. In some embodiments, extensible and retractable lift devices (e.g., hydraulic cylinders, actuators, etc.) are attached to the movable surfaces of a hospital bed to articulate these surfaces. In some embodiments, a control system (e.g., processor and/or controller) and/or electrical system directs movement of the mechanical lift devices to raise, lower, and position the bed as directed by a user, subject, and/or patient. In some embodiments, a control system (e.g., processor) and/or electrical system directs selective movement of several mechanical lift devices positioned along the hospital bed.

In some embodiments, a control means (e.g., control wand, control panel, control unit, and/or control circuitry) directs one or more adjustment means and/or mechanical lift devices (e.g., linear actuators, hydraulic cylinders, electric motors, etc.) to articulate a section of a support apparatus (e.g., hospital bed). In some embodiments, the adjustment means and/or mechanical lift devices (e.g., linear actuators, hydraulic cylinders, electric motors, etc.) are selectively operated to allow independent articulation of the various sections. For example, one or more linear actuators beneath the head portion of a hospital bed are activated to raise the head portion while leaving the lower body portion un-raised to provide a semi-seated position for the occupant. Alternatively, multiple linear actuators are activated in unison to raise the entire bed to a height indicated by a user, without altering the relative position of the occupant. Or, linear lift devices beneath the shoulders, knee, and feet are activated to elevate, while lift devices beneath the lumbar region and hips are lowered, to place the occupant in a semi-Fowler's position. In each of the aforementioned examples, uneven weight distribution across the bed (or other support apparatus) can result in the bed adopting an unlevel position or failing to precisely achieve the desired configuration. In some embodiments, autoleveling of the bed corrects for deviations from level, or deviations from the desired position. In some embodiments, an autoleveling device detects the incline of the bed, or a portion thereof (e.g., upper body region, lumbar region, foot, etc.), and compares it to the incline selected by a user or the occupant. If the detected (e.g., measured) and selected (e.g., reference) inclines differ beyond a set threshold, the autoleveling device directs the lift mechanisms (e.g., linear actuators) to level the bed and/or correct the discrepancy between the selected and detected inclines. In some embodiments, the autoleveling device directs the lift mechanisms via signals sent to the control system (e.g., control panel, processor, etc.) or electrical system of the bed. In some embodiments, while the autoleveling device and/or system relies on the lift mechanism to make the physical corrections to the incline of the bed or apparatus, the lift mechanisms do not provide information regarding the incline of the bed (e.g., incline information is lift mechanism independent).

In some embodiments, an autoleveling device of the invention integrates with the electrical circuitry of a hospital bed. In some embodiments, an autoleveling device of the invention integrates with the control system (e.g., processor, controller, control panel, etc.) of a hospital bed. In some embodiments, an autoleveling device integrates with the positioning machinery (e.g., adjustment means, lift mechanism, force unit, motor, actuator, etc.) of a hospital bed. In some embodiments, an autoleveling device integrates with the positioning machinery and control systems of a support apparatus. In some embodiments, an autoleveling device is integrated into the control circuitry between the control means (e.g., control wand, controller, etc.) and the adjustment means (e.g., lift mechanism). In some embodiments, an autoleveling device is inserted into the control logic flow between the control means (e.g., control wand, controller, etc.) and the adjustment means (e.g., lift mechanism). In some embodiments, an autoleveling device integrates with the positioning machinery to achieve leveled state (e.g., directs actuators or motors to raise or lower a portion of a hospital bed). In some embodiments, detection of an unlevel surface or apparatus by an autoleveling device is performed independent of the positioning machinery (e.g., measures the incline without feedback from actuators or motors). In some embodiments, an autoleveling device integrates with, while remaining independent from the positioning machinery (e.g., force unit, motor, actuator, etc.). In some embodiments, an autoleveling device directs positioning machinery to raise or lower a portion of a hospital bed. In some embodiments, an autoleveling device interprets signals (e.g., height, position, and/or incline adjustments signals) from the control means of a support apparatus when directing autoleveling thereof.

In some embodiments, an autoleveling device of the invention is configured to have multiple modes of operation. For example, in some embodiments, an autoleveling device is configured for operation in one or more reference modes including, but not limited to: “absolute reference mode,” “user-set reference mode,” and “auto-set reference mode.” In “absolute reference mode,” a device compares measured inclines to an absolute reference incline (e.g., a plane perpendicular to the force of gravity), and autolevels with respect to that absolute reference. In “user-set reference mode,” a user adjusts the apparatus to a desired incline and manually sets that incline as the reference incline (e.g., by depressing a level-set button). The autoleveling device then compares measured inclines to the user-set reference incline, and autolevels with respect to that reference. In “auto-set reference mode,” the autoleveling device automatically sets the reference incline following an affirmative change (e.g., intentional) in the incline or position of the apparatus. The autoleveling device then compares measured inclines to the auto-set reference incline, and autolevels with respect to that reference. In some embodiments, an autoleveling device is configured to operate in one or more timing modes including, but not limited to: “post-raise leveling mode,” “post-adjustment leveling mode,” “real-time leveling mode,” and “periodic-leveling mode.” In “post-raise leveling mode,” following an operator-induced increase in the height of the apparatus (up only, not down), the autoleveling device performs autoleveling (e.g., measuring the incline of the apparatus, comparing the measured incline to the set reference incline, and directing the apparatus controller to make any necessary adjustments). In “post-adjustment leveling mode,” following an operator-induced change in the height of the apparatus (up or down), the autoleveling device performs autoleveling (e.g., measuring the incline of the apparatus, comparing the measured incline to the set reference incline, and directing the apparatus controller to make any necessary adjustments). In “real-time leveling mode,” the autoleveling device constantly performs autoleveling, measuring the incline of the apparatus and comparing the measured incline to the set reference incline in real-time, and directing the apparatus controller to make any necessary adjustments whenever the two inclines are beyond an acceptable threshold. In “periodic leveling mode,” the autoleveling device periodically performs autoleveling (e.g., every 1 second, 1 minute, 2 minutes, 5 minutes, 10 minutes, 15 minutes, 20 minutes, 30 minutes, 1 hour, 1 day, time-points therein, etc.), measuring the incline of the apparatus and comparing the measured incline to the set reference incline at a user selected or inherent (e.g., pre-programmed) interval, and directing the apparatus controller to make any necessary adjustments whenever the two inclines are beyond an acceptable threshold. In some embodiments, an autoleveling device of the invention is configured to operate in one or more adjustment modes including, but not limited to: “post-raise leveling mode,” “post-lowering leveling mode,” and/or “post-adjustment leveling mode.”

In some embodiments, autoleveling of an object, surface, support apparatus, and/or hospital bed corrects deviations and inaccuracies in inclination. Deviations in inclination may occur as a result of normal repeated changes in height, incline, and/or positions of an apparatus, surface, and/or hospital bed. Deviations in inclination may occur as a result of differences between the strength and/or position of one or more (e.g. two or more) lift mechanisms (e.g., actuators). Deviations in inclination may occur as a result of changes in the mass of the load on an apparatus, surface, and/or hospital bed. Deviations in inclination may occur as a result of changes distribution of the load on an apparatus, surface, and/or hospital bed. Indeed, any type of deviation resulting from these or other events may be addressed and corrected using a device of the invention.

In some embodiments, autoleveling provides a safety backup for an apparatus, surface, and/or hospital bed. In some embodiments, an autoleveling device detects changes and/or deviations from a reference of the incline of an apparatus or surface, and directs the lift mechanisms to correct the deviation. In some embodiments, an autoleveling device recognizes prolonged deviation in incline of a surface, apparatus, or hospital bed. In some embodiments, a warning (e.g., visual, audio, etc.) is generated upon recognition by an autoleveling device of prolonged deviation in incline of a surface, apparatus, or hospital bed. In some embodiments, upon recognition of prolonged deviation in incline of a surface, apparatus, or hospital bed, an autoleveling device directs the controller and/or lift mechanisms to return the surface, apparatus, or hospital bed to a safe incline and/or position (e.g., low height, horizontal, etc.).

In some embodiments, an autoleveling device detects the incline of an apparatus or surface and compares the detected incline to a reference incline. In some embodiments, detection of apparatus incline is performed constantly and/or in real time. In some embodiments, detection of apparatus incline is performed periodically (e.g., every 0.1 second, 1 second, 1 minute, 2 minutes, 5 minutes, 10 minutes, 15 minutes, 20 minutes, 30 minutes, 1 hour, 1 day, time-points therein, etc.), according to an inherent, pre-programmed, and/or defined schedule. In some embodiments, detection of apparatus incline is performed following alteration or adjustment (e.g., user-initiated or automatic) of the apparatus height or position.

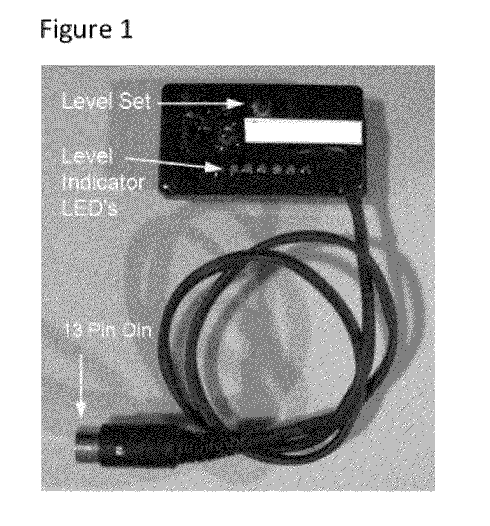

In some embodiments, an autoleveling device comprises, consists of, or consists essentially of a position feedback device (e.g., inclinometer, accelerometer, etc.), processor, level-set mechanism, and apparatus integration element(s). An autoleveling device may further comprise a level indicator, display, control mechanism (e.g., control panel), and other useful features. In some embodiments, an autoleveling device comprises a level-set, level indicator, position feedback device (e.g., inclinometer (e.g., digital inclinometer)), and apparatus integration element (e.g., cord) (SEE FIG. 1). In some embodiments, the invention comprises one or more (e.g., 1, 2, 3, 4, 5, 6, etc.) position feedback devices (e.g., inclinometer, clinometer, tilt meter, tilt indicator, slope alert, slope gauge, gradient meter, gradiometer, level gauge, level meter, declinometer, accelerometer, etc.). In some embodiments, a position feedback device (e.g., inclinometer) determines the incline, slope, and/or angle of the inclinometer or an attached apparatus or surface (e.g., hospital bed). In some embodiments, a position feedback device (e.g., inclinometer) measures incline with respect to a user defined reference (e.g., a desired seat back incline). In some embodiments, a position feedback device (e.g., inclinometer) measures incline with respect to the ground or floor (e.g., parallel to ground). In some embodiments, a position feedback device (e.g., inclinometer) measures incline with respect to the force of gravity (e.g., perpendicular to the force of gravity). In some embodiments, a position feedback device (e.g., inclinometer) generates an artificial horizon (e.g., perpendicular to the force of gravity) and measures the tilt angle with respect to this horizon. In some embodiments, a position feedback device comprises an inclinometer. In some embodiments, an inclinometer suitable for use in the invention functions by any suitable sensor technology, including, but not limited to: accelerometer, Liquid Capacitive, electrolytic, gas bubble in liquid, solid state, pendulum, etc. In some embodiments, an inclinometer comprises one or more micromachined accelerometers. In some embodiment, an inclinometer is a digital inclinometer. In some embodiments, a digital inclinometer comprises attributes from one or more of U.S. Pat. No. 7,565,748; U.S. Pat. No. 6,880,258; U.S. Pat. No. 5,761,818; U.S. Pat. No. 5,517,430; U.S. Pat. No. 4,942,668; U.S. Pat. No. 4,694,584; and U.S. Pat. No. 4,606,133. In some embodiments, the invention provides a single inclinometer. In some embodiments, the invention provides a single inclinometer configured to measure incline along a single axis. In some embodiments, a single inclinometer is configured to measure incline along multiple axes (e.g., 2, 3, 4, 5, 6, etc.). In some embodiments, an inclinometer is a multi-axis inclinometer. In some embodiments, the invention provides multiple inclinometers. In some embodiments, multiple inclinometers (e.g., 2, 3) measure the inline of an apparatus (e.g., hospital bed) along multiple axes. In some embodiments, multiple inclinometers (e.g., 2, 3, 4, 5, 6, 7, 8, etc.) measure the inline of an apparatus (e.g., hospital bed) at different positions along the apparatus. In some embodiments, the invention provides multiple inclinometers, each capable of measuring incline along multiple axes. In some embodiments, an inclinometer for use with the invention is accurate to at least ±2° (e.g., ±2° . . . ±1° . . . ±0.5° . . . ±0.2° . . . ±0.1° . . . ±0.05° . . . ±0.02° . . . ±0.01°).

In some embodiments, an autoleveling device comprises a processor (e.g., microprocessor). In some embodiments, the processor receives and/or processes information (e.g., voltage information, analog information, digital information, etc.) transmitted from, for example, the position feedback device (e.g., inclinometer, accelerometer, etc.), an apparatus controller (e.g., hospital bed controller), the autoleveling device control panel, etc. In some embodiments, upon the occurrence of one or more conditions (e.g., deviation between detected incline and reference incline following a user-initiated rise in height of the apparatus), the processor transmits directions (e.g., via electrical current) to the apparatus controller to enable and/or initiate adjusting the height, incline, and/or position of the apparatus. In some embodiments, upon the occurrence of one or more conditions (e.g., deviation between detected incline and reference incline following a user-initiated rise in height of the apparatus), the processor transmits directions (e.g., via electrical current) to one or more of the lift mechanisms of an apparatus to enable and/or initiate adjusting the height, incline, and/or position of the apparatus. In some embodiments, the autoleveling processor compares measurements of incline transmitted from a position feedback device (e.g., inclinometer, accelerometer, etc.) to reference inclines (e.g., saved in memory accessible by the processor). In some embodiments, upon detecting variation (e.g., beyond an allowable threshold) between an inclinometer-measured incline and a reference incline, the autoleveling processor transmits instructions to the apparatus controller to enable one or more lift mechanisms to adjust the apparatus incline to correct the deviation. In some embodiments, upon detecting variation (e.g., beyond an allowable threshold) between an inclinometer-measured incline and a reference incline, the autoleveling processor transmits instructions directly to one or more lift mechanisms, enabling adjustment of the apparatus incline to correct the deviation. In some embodiments, the autoleveling device processor receives instructions from the apparatus controller (e.g., to set level incline, to take incline measurements, to disable incline measurements, etc.). In some embodiments, the autoleveling processor relays received instructions (e.g., from the inclinometer, from the apparatus controller, etc.) to a destination (e.g., inclinometer, lift mechanism, controller, etc.) to produce the desired and/or intended effect (e.g., raise a portion of the apparatus, lower a portion of the apparatus, raise one a portion of the apparatus and lower one portion of the apparatus, enable a lift mechanism, set level, etc.).

In some embodiments, an autoleveling device is configured to interact wirelessly with one or more elements of a support apparatus or the lift mechanism or controller thereof. In some embodiments, an autoleveling device performs autoleveling functions described herein, and communicates with the lift mechanism(s), controller, control circuitry, etc. of the support apparatus wirelessly. In some embodiments, an autoleveling device comprises one or more wireless transmitters and/or receivers for wireless communication with a support apparatus or elements thereof.

In some embodiments, an autoleveling device comprises one or more analog to digital (A/D) converters, ports, devices, chips, etc. (e.g., an analog to digital port within the microprocessor, an analog to digital converter attached to the microprocessor, etc.). In some embodiments, an A/D converter converts an analog signal to a digital signal. In some embodiments, a digital microprocessor performs one or more logic algorithms related to the autoleveling procedure. In some embodiments, one or more logic algorithms performed by the microprocessor require input from a position feedback device (e.g., inclinometer), support apparatus, or other analog devices or components (analog input). In some embodiments, an A/D device (e.g., converter, port, etc.) converts analog signals from a position feedback device (e.g., inclinometer), support apparatus, or other analog devices or systems into digital signals that are utilized by logic algorithms (e.g. run by the processor and/or stored in a memory unit).

In some embodiments, an autoleveling device comprises one or more digital to analog (D/A) converters, ports, devices, chips, etc. (e.g., a digital to analog port within the microprocessor, a digital to analog converter attached to the microprocessor, etc.). In some embodiments, a D/A converts a digital signal to an analog signal. In some embodiments, as a result of one or more logic algorithms performed by the microprocessor, an output signal (e.g., instructions) is sent from the autoleveling device processor to the lift mechanism (e.g., actuators), support apparatus, control unit, or other analog device or component. In some embodiments, a D/A device (e.g., converter, port, etc.) converts the digital signals generated by the autoleveling device processor into analog signals that are sent to the lift mechanism (e.g., actuators), support apparatus, control unit, or other analog device or component (e.g., thereby controlling movement of the lift mechanism (e.g., actuators), support apparatus, control unit, or other analog device or component).

In some embodiments, an autoleveling device comprises a de-bounce element, mechanism, component, device, circuit, software, algorithm, and/or procedure. In some embodiments, de-bouncing comprises removing erroneous spikes in a transmitted signal (e.g., spikes resulting from pressing a button, flipping a switch, or other phenomena associated with device operation). In some embodiments, de-bouncing filters out erroneous signals and/or readings from a position feedback device (e.g., inclinometer), key input, user input, and/or outputs. In some embodiments, de-bouncing filters out erroneous signals that are the result of electromagnetic interference (EMI). In some embodiments, de-bouncing provides a clean signal transition. In some embodiments, de-bouncing is performed by software and/or a de-bouncing algorithm. In some embodiments, de-bouncing is performed by comparing the current value of a position feedback device (e.g., inclinometer, accelerometer, etc.) to the previous value, and rejecting the current value if the change is greater than a set tolerance. In some embodiments, de-bouncing is performed by comparing the current value of a position feedback device (e.g., inclinometer, accelerometer, etc.) to the previous value, and rejecting the current value if the change is greater than a window of error to provide system stability (e.g. +/−1% . . . 2% . . . 5% . . . 10% . . . 20%, etc. depending on the application). In some embodiments, software de-bouncing (e.g., for key inputs and outputs) is achieved using a delay to allow the electronic signals to settle and/or stabilize prior to reading.

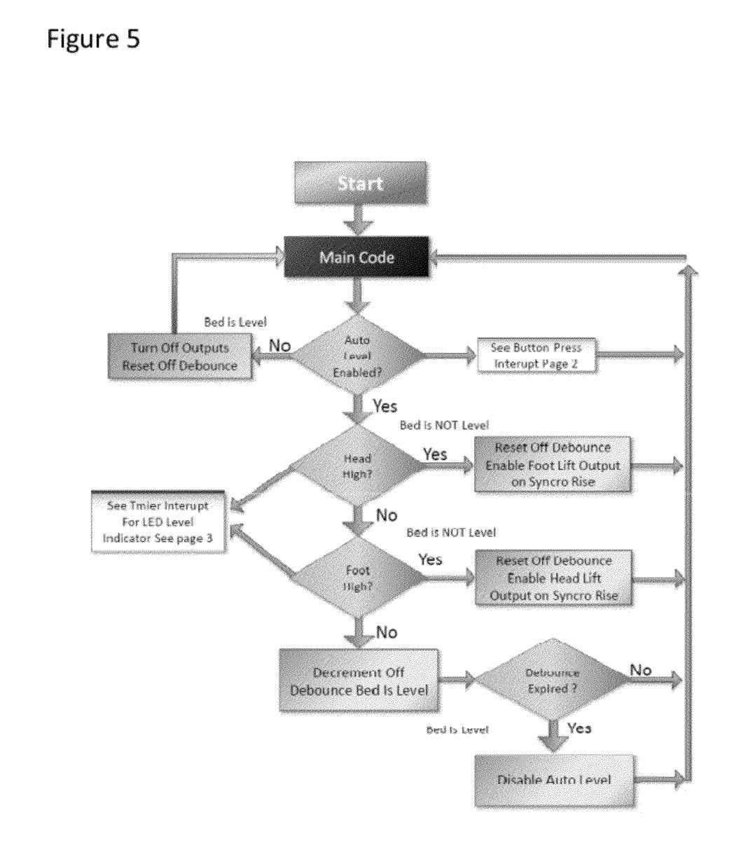

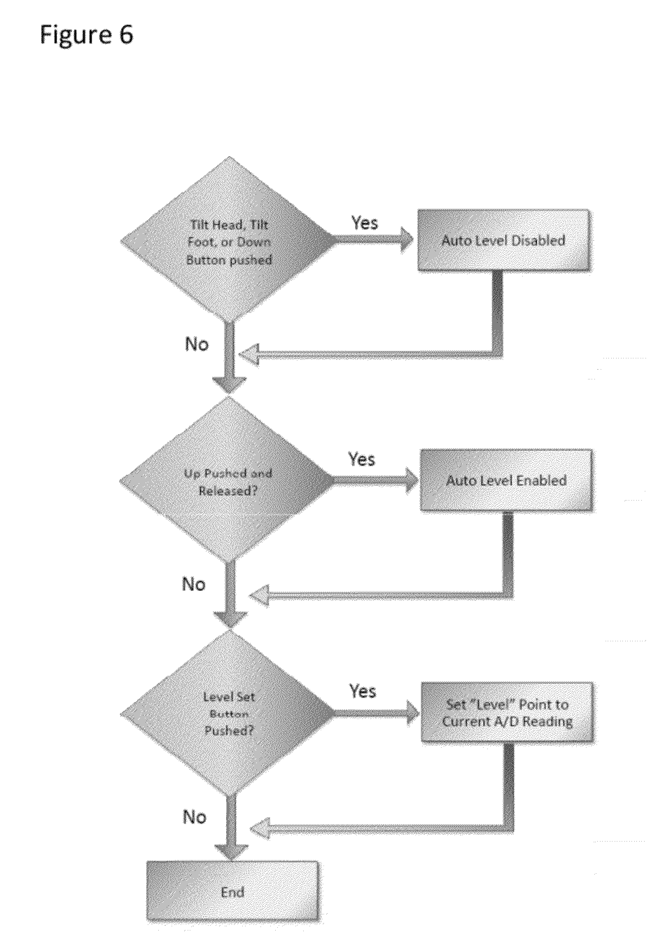

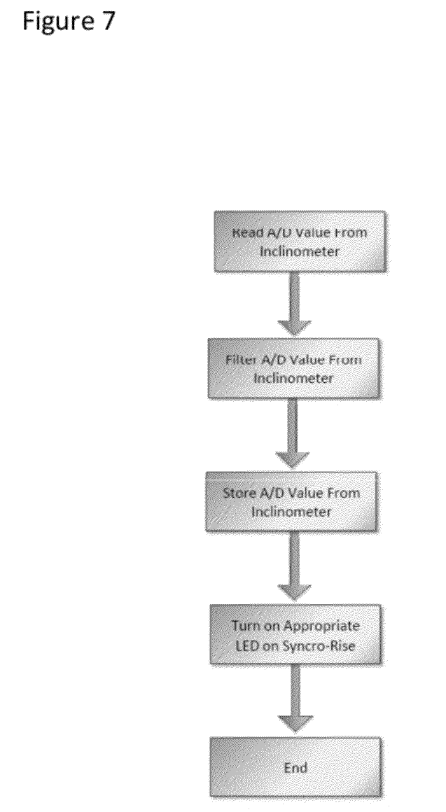

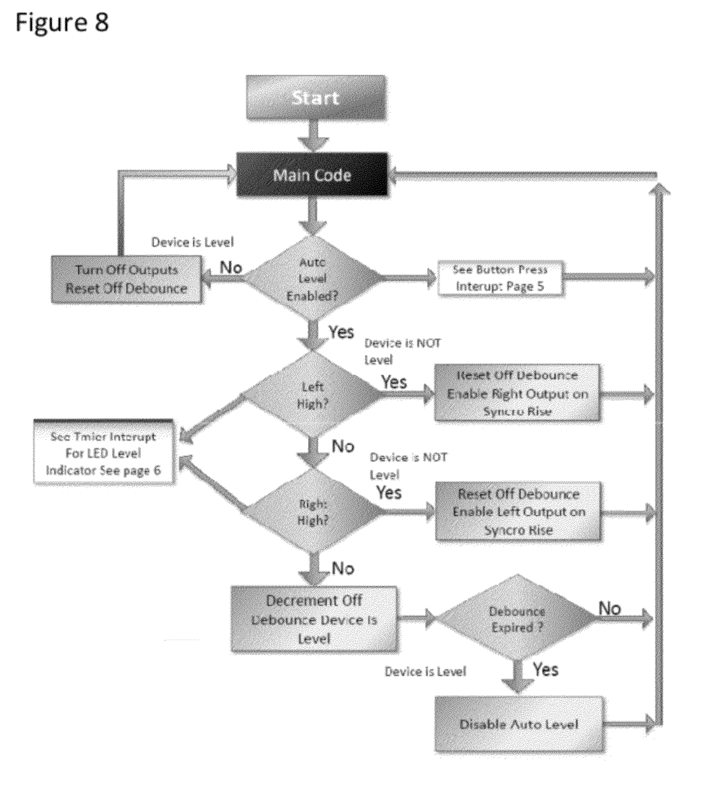

In some embodiments, the autoleveling of a support apparatus (e.g., hospital bed) is controlled by a processor (e.g., microprocessor). In some embodiments, the main code of the microprocessor enables, disables, and directs autoleveling (SEE, e.g., FIGS. 5 and 8). In some embodiments, a microprocessor disables the autoleveling device when user initiated adjustments are being made to the incline or position of a hospital bed (e.g., tilt head, tilt foot, or down button pushed) (SEE FIG. 6). In some embodiments, the microprocessor monitors changes in position and/or incline and re-enables the autolevel function upon termination of adjustment (e.g., release of button) (SEE FIG. 6). In some embodiments, the incline reference is set following depressing the level-set button. In some embodiments, the level-set button is used to set the reference incline whether or not the autolevel function is enabled. In some embodiments, when the level-set button is depressed, the reference incline is set to the current incline (e.g., A/D value). In some embodiments, the current incline (e.g., A/D value) is measured by the position feedback device (e.g., inclinometer). In some embodiments, the microprocessor directs reading of the A/D value from the position feedback device (e.g., inclinometer), filtering of the A/D value, and/or storing of the A/D value in a memory component (SEE FIG. 7). In some embodiments, the microprocessor enables display of the hospital bed's incline relative to a reference incline on a user display (e.g., LED incline indicator).

In some embodiments, the autoleveling function of an autoleveling device can be enabled or disabled automatically (e.g., under a programmed set of conditions) or manually (e.g., by a user). In some embodiments, the autoleveling function of an autoleveling device is automatically disabled when user-initiated adjustments are being made to the incline or position of a hospital bed (e.g., tilt head, tilt foot, or down button pushed). In some embodiments, the autoleveling function of an autoleveling device is automatically re-enabled following completion of user-initiated adjustments to the incline or position of a hospital bed. In some embodiments, autoleveling function is disabled by a manual override. In some embodiments, autoleveling function is disabled following automatic or user-initiated decrease in height. In some embodiments, an autoleveling device can be programmed and/or pre-programmed to enable or disable autoleveling function upon detection of any combination of conditions.

In some embodiments, an autoleveling device comprises a user interface and/or control panel. In some embodiments, a user interface comprises one or more mechanisms (e.g., buttons, touch screen, knobs, levers, etc.) through which a user can interact with the autoleveling device (e.g., set level, take manual incline measurement, enable/disable autoleveling device, set mode (e.g., autoleveling mode, reference mode, etc.). In some embodiments, user instructions entered into the control panel are transmitted to one or more of an autoleveling device processor, apparatus processor, apparatus controller, apparatus adjustment means (e.g., lift mechanism, actuators, etc.) position feedback device (e.g., inclinometer), etc. In some embodiments, user instructions entered into the control panel are displayed on an autoleveling device user display. In some embodiments, an autoleveling device integrates with the user interface of a support apparatus (e.g. hospital bed). In some embodiments, an autoleveling device is “retrofit” with an independent support apparatus. In some embodiments, a “retrofit” autoleveling device utilizes the user interface of the support apparatus.

In some embodiments, an autoleveling device comprises a user display (e.g., indicator LED's, monitor, screen, etc.). In some embodiments, a user display provides visual depiction of selections made by an operator and/or user (e.g., autoleveling mode, manual incline measurements). In some embodiments, a user display provides visual indication of a comparison between measured incline and reference incline. In some embodiments, a user display provides visual indication of changes in incline of the apparatus which have been initiated by the autoleveling device. In some embodiments, a user display provides visual indication of the alignment of the measured incline with the reference incline. In some embodiments, a user display provides an audio indication of changes in incline of the apparatus which have been initiated by the autoleveling device. In some embodiments, a user display provides an audio indication (e.g., warning) that the apparatus is unlevel. In some embodiments, a user display provides audio indication of the alignment of the measured incline with the reference incline.

In some embodiments, an autoleveling device comprises a memory component (e.g. firmware, flash memory, etc.). In some embodiments, a memory component is accessible by the autoleveling device processor. In some embodiments, a memory component stores information including, but not limited to reference inclines, modes, adjustment history, incline history, etc.

In some embodiments, an autoleveling device comprises a housing. In some embodiments, a housing encloses one or more elements (e.g., inclinometer, processor, etc.) of the invention. In some embodiments, a housing provides a means for attaching an autoleveling device to a support apparatus (e.g., bracket, magnet, screws, latch, etc.). In some embodiments, a housing provides for generic attachment to support apparatuses. In some embodiments, a housing provides attachment means specific to a type, make, and or model of support apparatus or hospital bed. In some embodiments, a housing provides one or more adapters for attachment to a support apparatus or hospital bed. In some embodiments, a housing fully encloses an autoleveling device. In some embodiments, a housing fully encloses portions of an autoleveling device (e.g., inclinometer, processor, etc.). In some embodiments, a housing allows a user to access and physically interact with the user interface (e.g., control panel), level-set button, etc. In some embodiments, a housing allows a user to view the user display.

In some embodiments, the invention provides an autoleveling system. In some embodiments, an autoleveling system comprises one or more autoleveling devices, each comprising one or more single or multi-axis inclinometers. In some embodiments, an autoleveling systems provide autoleveling functionality for support apparatuses and/or hospital beds with multiple segments capable of independent adjustment, and/or inclination. In some embodiments, an autoleveling system provides autoleveling functionality for support apparatuses and/or hospital beds capable of adopting multiple dissimilar positions (e.g., horizontal, incline, semi-Fowlers, lithotomy position, Trendelenburg, etc.). In some embodiments, an autoleveling system comprises an autoleveling device for each independently actuatable segment of a support apparatus or hospital bed. In some embodiments, each autoleveling deice of an autoleveling system provides one or more independent functionalities (e.g., setting reference, measuring incline, transmitting leveling instructions, etc.). In some embodiments, a central processor or controller of an autoleveling system provides one or more functionalities of the autoleveling devices (e.g., transmitting leveling instructions to support apparatus, coordinating level-sets and/or incline measurements, etc.). In some embodiments, a central processor or controller of an autoleveling system coordinates one or more functionalities of the autoleveling devices and the support apparatus or hospital bed. In some embodiments, an autoleveling system comprises multiple peripheral inclinometers for independently actuatable segment of a support apparatus or hospital bed, and a single central unit comprising a processor, memory, user interface, user display, etc. In some embodiments, an autoleveling system comprises one peripheral inclinometer each for independently actuatable segment of a support apparatus or hospital bed.

Devices of the invention provide autoleveling capability for support apparatuses, lift apparatuses, chairs, beds, cots, position apparatuses, and/or support devices. Unless otherwise specified, embodiments described herein referring to the term “hospital bed” are also applicable to other support and/or lift apparatuses and/or devices.

Exemplary support apparatuses which find use with the invention are described in, for example U.S. Pat. No. 7,610,637; U.S. Pat. No. 7,017,208; U.S. Pat. No. 4,751,754; U.S. Pat. No. 5,613,255; U.S. Pat. No. 5,884,350; U.S. Pat. No. 5,230,112; and U.S. Pat. No. 5,161,274; U.S. Pat. No. 5,077,843; U.S. Pat. No. 4,751,754; U.S. Pat. No. 5,157,800; U.S. Pat. No. 5,129,177; U.S. Pat. No. 4,862,529; U.S. Pat. No. 5,279,010; U.S. Pat. No. 4,183,109; U.S. Pat. No. 4,411,035; and U.S. Pat. No. 3,220,022; herein incorporated by reference in their entireties, though it should be understood that other patient support apparatuses may be used.

In some embodiments, support apparatuses comprise one or more controller means. In some embodiments, a controller comprises, but is not limited to, one or more of processor, user interface, display, controller wand, connection to lift mechanism(s), etc. In some embodiments, the user interface of a support apparatus controller comprises user-engageable elements (e.g., buttons) which provide means for directing movement, adjustment, re-positioning, elevating, etc. of a support apparatus. In some embodiments, a controller means comprises a processor (apparatus processor). In some embodiments, a controller means comprises two or more components (e.g., wand and controller unit). In some embodiments, a controller, or component thereof, is operatively connected (e.g., via control circuitry, via electrical circuitry, etc.) to an apparatus lift mechanism. In some embodiments, a controller, or component thereof, is directly connected (e.g., via control circuitry, via electrical circuitry, etc.) to an apparatus lift mechanism. In some embodiments, a controller, or component thereof, is indirectly connected (e.g., via control circuitry, via electrical circuitry, etc.) to an apparatus lift mechanism.

In some embodiments, a support apparatus (e.g. lacking autoleveling capability) is retrofit with an autoleveling device of the invention. In some embodiments, an autoleveling device is retrofit to a support apparatus (e.g. hospital bed) to provide autoleveling capability. In some embodiments, an autoleveling device provides certain systems (e.g. position feedback element) and functionalities (detecting and comparing inclines) and integrates with certain systems (e.g. user interface, control circuitry, etc.) and functionalities (apparatus lifting) of the support apparatus. In some embodiments, an autoleveling retrofit provides autoleveling capability to support apparatuses (e.g. hospital beds) previously lacking such functionality without need for potentially expensive replacement of the apparatus.

In some embodiments, support apparatuses comprise one or more lift mechanisms and/or adjustment means. In some embodiments, an adjustment means and/or lift apparatus comprises a linear actuator. In some embodiments, a linear actuator comprises a mechanical actuator, hydraulic actuator, pneumatic actuator, piezoelectric actuator, electromechanical actuator, segmented spindle actuator, moving coil actuator, helical band actuator, rigid chain actuator, rigid belt actuator, etc. In some embodiments, an adjustment means and/or lift apparatus comprises a belt drive, chain drive, ball screw, hoist, roller screw, etc. In some embodiments, a lift mechanism and/or adjustment means comprises any suitable mechanism, device, system, and/or apparatus configured to raise and lower a support apparatus, or a segment thereof. In some embodiments, a lift mechanism and/or adjustment means raises or lowers a support apparatus, or a portion thereof, through any suitable mechanism which may be particular to the type of lift mechanism, and is understood by one of skill in the art. In some embodiments, actuators which find use with the invention are produced by a variety of manufacturers including, but not limited to: DEWERT (U.S. Pat. No. 6,452,350; U.S. Pat. No. 6,240,800; herein incorporated by reference in their entireties), LINAK (U.S. Pat. No. 7,685,898; U.S. Pat. No. 7,619,898; U.S. Pat. No. 7,506,560; U.S. Pat. No. 7,495,359; U.S. Pat. No. 7,163,184; U.S. Pat. No. 6,841,953; U.S. Pat. No. 6,739,004; U.S. Pat. No. 5,918,505; herein incorporated by reference in their entireties), OKIN (U.S. Pat. No. 7,567,050; herein incorporated by reference in its entirety), PHOENIX MECANO, LIMOSS, CIAR, REFINED MECHANICS, and RAFFLE SYSTEMS. In some embodiments, an autoleveling device of the invention is configured for connection to, integration with, and/or autoleveling via any lift mechanisms (e.g., actuators) described herein or known to those in the art. In some embodiments, an autoleveling device is configured for universal attachment to lift mechanisms (e.g., actuators) or support apparatuses (e.g., hospital beds). In some embodiments, an autoleveling device is configured for universal attachment to actuator-driven support apparatuses (e.g., hospital beds).

In some embodiments, an autoleveling device is attached to a support apparatus by any suitable method or means including, but not limited to: fixed attachment, removable fixed attachment, magnetic attachment, adhesive attachment (e.g. tape), bolt or screw attachment, brackets, glue, harness, integrated into the apparatus, and/or a combination of attachment means.

In some embodiments, lift mechanism and/or adjustment means is operatively connected to the electrical and/or control circuitry of a support apparatus (e.g., hospital bed). In some embodiments, instructions to raise or lower a support apparatus, or a portion thereof, are transmitted to a lift mechanisms and/or adjustment means via electrical or control circuitry (e.g., from an apparatus controller or position feedback device). In some embodiments, support apparatuses, and the corresponding lift mechanisms and/or control units, are configured to perform height adjustments. In some embodiments, support apparatuses, and the corresponding lift mechanisms and/or control units, are configured to perform position adjustments.

In some embodiments, an autoleveling device of the invention is integrated with, and/or connected to one or more systems (e.g., control system, electrical system, mechanical system, lift system, etc.) of a hospital bed or support apparatus. In some embodiments, a control system (e.g., lift control system) of a hospital bed is expanded by the addition of an external autoleveling device. In some embodiments, an autoleveling device is connected to, or integrated with a control system (e.g., lift control system). In some embodiments, an autoleveling device is not part of the control system of a hospital bed, but is connected to the control system. In some embodiments, an autoleveling device is an independent device that connects to, or integrates with, a hospital bed (e.g., control system of a hospital bed) to impart autoleveling functionality to the bed. In some embodiments, a hospital bed and/or the control system for a hospital bed is designed and/or configured for connection to, or integration with, an autoleveling device of the invention. In some embodiments, an autoleveling device is designed and/or configured for connection to, or integration with, a hospital bed and/or control system (e.g., specific make and/or model). In some embodiments, an autoleveling device is configured for universal connection to, or integration with, hospital beds. In some embodiments, an autoleveling device is configured for connection to, or integration with, a wide variety of hospital beds (e.g., makes and/or models). In some embodiments, an autoleveling device is connected to, or integrated with existing hospital beds or control systems thereof (e.g., retrofit). In some embodiments, an autoleveling device is configured for attachment to hospital beds and/or control systems thereof through any suitable connection means (e.g., 2 Pin Din plug, 3 Pin Din plug, 3 Pin Din inline jack, 4 Pin Din plug, 5 Pin Din (180° spread), 5 Pin Din inline jack (240° pin spread), 6 Pin Din plug, 6 Pin Din inline jack, 7 Pin Din plug, 7 Pin Din inline jack, 8 Pin Din plug (270° pin spread), 8 Pin Din Inline jack (270° pin spread), 8 Pin Din plug (262° pin spread), 13 Pin Din plug, 4 PIN MINI DIN plug, 6 PIN MINI DIN plug, 6 PIN MINI DIN jack, 8 PIN MINI DIN plug, 8 PIN MINI DIN jack, USB, mini-USB, coaxial cable, firewire, RCA cable, wireless transmitter chip in device in lieu of card, etc.). In some embodiments, an autoleveling device is configured for connection to, or integration with the lift mechanism of a support apparatus. In some embodiments, an autoleveling device is configured for connection to, or integration with the control means of a support apparatus. In some embodiments, an autoleveling device is configured for connection to, or integration with the electric circuitry and/or control circuitry of a support apparatus.

In some embodiments, the lift mechanism of a support apparatus is connected to the control means via electric circuitry (e.g., control circuitry). In some embodiments, an external autoleveling device is integrated with the support apparatus via the electric circuitry (e.g., control circuitry). In some embodiments, an external autoleveling device is integrated with the support apparatus by insertion into the electric circuitry (e.g., control circuitry). In some embodiments, the control circuitry connecting the apparatus control means with the lift mechanism is routed through an autoleveling device. In some embodiments, control information transmitted from the control means to the lift mechanism is routed through the autoleveling device. In some embodiments, routing of control information through the autoleveling device permits autoleveling to be performed based on directions and conditions set by the control unit (e.g., autoleveling following a change in height, set reference incline following user-initiated change in height, etc.) In some embodiments, integration of an autoleveling device into the control circuitry for a lift mechanism allows the autoleveling device to direct the lift mechanism to alter the incline of the support apparatus to correct undesired deviations in incline. In some embodiments, an autoleveling device is configured for integration into the control circuitry via any suitable methods known to those of skill in the art. In some embodiments, an autoleveling device is configured to retrofitting a support apparatus (e.g., hospital bed) lacking an autoleveling functionality. In some embodiments, an autoleveling device is configured for attachment to the circuitry of standard support apparatuses and lift mechanisms.

### Experimental

The following section provides exemplary embodiments of the invention, and should not be considered to be limiting of its scope with regard to alternative embodiments that are not explicitly described herein.

### EXAMPLE 1

### Retrofit Autoleveling Device

A position feedback device comprising an inclinometer device that utilizes a microprocessor to perform autoleveling is attached to a hospital bed to ensure the bed resides within a threshold deviation from a user defined slope. Anytime the “UP” button is depressed (SEE FIG. 1) on the Limited or Full Featured Wand, the autoleveling device is activated to perform the auto leveling function of the bed. Conversely, the autoleveling device is disabled and autoleveling is not performed when the “DN” button is depressed, due to the possibility of a crushing hazard.

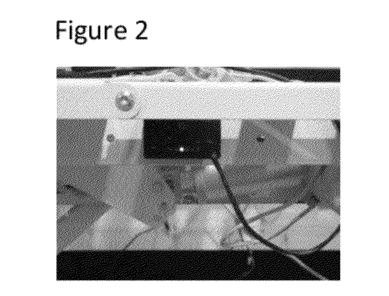

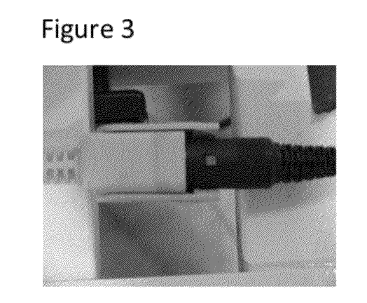

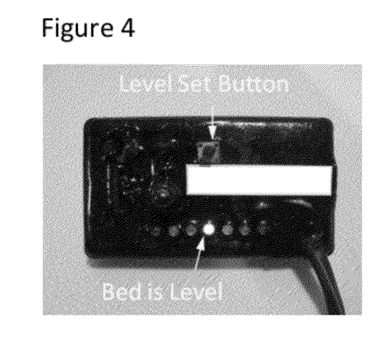

To connect the autoleveling device to the bed, the power is first turned off the bed controller. With the power off to the controller, the autoleveling device is affixed (e.g. by an attached magnet) to the horizontal portion of the bed frame (SEE FIG. 2). A 13 pin din connector is connected to the unused end of a Y-cord (SEE FIG. 3). The Y cord provides the logic and power to the wand hand control, and the unused end is free for attachment to the autoleveling device. In the event that both ends of the Y-cord are used, an additional Y-cord can be inserted. Power is applied to the controller. The height of the bed is adjusted to its highest level, and the “Level Set” button on autoleveling device is depressed (e.g. for approximately 2 seconds) and subsequently released (SEE FIG. 4), thereby calibrating the device.

The bed is then lowered to a lower position, and the bed is loaded off center with approximately 200 pounds to simulate a patient. The bed is raised to its upper limit. The autoleveling device insures that, despite the weight imbalance, the bed reaches the maximum height and is level within a 1° threshold. When the same lift is performed in the absence of an autoleveling device, due to the imbalance of weight, the bed is unlevel, with a disparity of approximately 3 inches in height difference from one end to the other, corresponding to 2° from level.

### EXAMPLE 2

### Exemplary Embodiments

Exemplary embodiments of autoleveling devices and support apparatuses within the scope of the invention are provided below. One of skill in the art understands well that the components described below can be altered, for general operation or for specific situational purpose. Combinations of the following embodiments, as well as additional features, are within the scope of the invention. The following examples should be viewed as exemplary and not limiting.

### Single-Axis Autoleveling, Real-Time Correction

In some embodiments, the invention provides a single-axis autoleveling device and a support apparatus (e.g., hospital bed) capable of elevating and decreasing height. The autoleveling device comprises a digital inclinometer, processor, level-set mechanism, and an integration cord. The support apparatus (e.g., hospital bed) comprises one lift mechanism at the head, one lift mechanism at the foot, and a controller which directs extension and retraction of the lift mechanisms. The autoleveling device is mounted on the support apparatus (e.g., hospital bed) in a configuration wherein the inclinometer is capable of sensing changes in the incline in the head to the foot orientation. The level-set mechanism is used to set reference incline as perpendicular to the force of gravity. The integration cord is connected to the controller of the support apparatus (e.g., hospital bed) so as to allow the autoleveling device to transmit leveling instructions to the controller. Autoleveling instructions include: (1) extending the lift mechanism at the head of the bed, and (2) extending the lift mechanism at the foot of the bed. The inclinometer makes real-time measurements of the incline of the support apparatus (e.g., hospital bed). The processor of the autoleveling device compares the real-time incline measurements to the reference incline. If a deviation between the measured incline and reference is detected, the autoleveling device instructs the controller to enable either the head or foot lift mechanism to correct the height disparity, and return the support apparatus (e.g., hospital bed) to level. If the inclinometer detects an incline in which the head is higher than the foot, when compared to the reference incline, the processor transmits instructions to the controller to elevate the foot of the bed by extending the lift mechanism at the foot of the bed. If the inclinometer detects an incline in which the foot is higher than the head, when compared to the reference incline, the processor transmits instructions to the controller to elevate the head by extending the lift mechanism at the head. Through real-time measurements of the support apparatus (e.g., hospital bed) incline, comparison of measured incline to reference incline, transmitting instructions to the controller, and enabling the appropriate lift mechanism, the autoleveling device maintains a level status of the support apparatus (e.g., hospital bed). Deviations caused by adjustments in the height of the support apparatus (e.g., hospital bed) and/or changes in the mass and distribution of load are thereby corrected.

### Single-Axis Autoleveling, Post-Elevation Correction

In some embodiments, the invention provides a single-axis autoleveling device comprising a digital inclinometer, processor, level-set mechanism, and an integration cord; and a support apparatus (e.g., hospital bed) comprising a head lift mechanism, foot lift mechanism at the foot of the apparatus, and a controller which directs extension and retraction of the lift mechanisms. The autoleveling device is mounted on the support apparatus (e.g., hospital bed) in a configuration wherein the inclinometer is capable of sensing changes in the incline from the head to the foot, and the integration cord is connected to the controller of the apparatus so as to allow the autoleveling device to transmit leveling instructions to the controller. Upon raising of the support apparatus (e.g., hospital bed) by a user, via the controller, the inclinometer is configured to measure the incline of the apparatus. The processor then compares the measured incline to a reference incline. The processor is configured to direct the controller to (1) extend the head lift mechanism if the measured incline deviates from the reference incline such that the foot end is higher than the head, and (2) extend the foot lift mechanism if the measured incline deviates from the reference incline such that the head end is higher than the foot. Thereby, the autoleveling device described above corrects deviations in the inclination of a support apparatus (e.g., hospital bed) following increases in the bed height initiated by a user.

### Dual-Axis Autoleveling

In some embodiments, the invention provides a dual-axis autoleveling device comprising two digital inclinometers, a processor, level-set mechanism, and an integration cord; and a support apparatus comprising four lift mechanisms positioned in the top/right, top/left, bottom/right, and bottom/left corners, and a controller which directs extension and retraction of the lift mechanisms. The inclinometers of the dual-axis autoleveling device are configured to detect the incline along two orthogonal axes. The autoleveling device is mounted on the support apparatus in a configuration wherein the inclinometers are capable of sensing changes in the incline from the top to bottom and left to right of the apparatus. The integration cord is connected to the controller of the apparatus so as to allow the autoleveling device to transmit leveling instructions to the controller. The inclinometers make measurements of the incline of the support apparatus (e.g., real-time measurements of measurements following height adjustments). The processor of the autoleveling device compares the incline measurements to reference inclines along each axis. If a deviation between the measured inclines and reference inclines is detected, the autoleveling device instructs the controller to enable the appropriate lift mechanism to correct the height disparity, and return the support apparatus to level. The processor directs the controller to enable the two right-side lift mechanisms or two left-side lift mechanisms to correct left to right or right to left incline disparity. Likewise, the processor direct the controller to enable the two top lift mechanisms or two bottom lift mechanisms to correct bottom to top or top to bottom disparity. The processor will direct the controller to enable a combination of lift mechanisms to the proper degree to correct for disparity in the incline along both axes. A dual-axis autoleveling device as described above provides correction of incline deviations caused by adjustments in the height of the support apparatus (e.g., hospital bed) and/or changes in the mass and distribution of load are thereby corrected.

### Non-Horizontal Autoleveling

In some embodiments, a system of the invention comprises a single-axis autoleveling device and support apparatus as described above. The device may be a real-time autoleveling device, a post-elevation autoleveling device, or a selectable device capable of performing either autoleveling function. The support apparatus comprises a head lift mechanism and a foot lift mechanism, which are capable of operating independently to place the support apparatus at an incline with respect to the horizontal, as selected by a user. The support apparatus is placed at an incline by enabling extension of one lift mechanism, but not the other. Following extension of one of the lifts, for example, the head lift mechanism, the autoleveling device sets the newly adjusted slope as the reference incline, or level. Depending upon the device and/or the autoleveling mode selected, the reference incline is set automatically upon completion of the incline adjustment, or a user must depress a level-set button to set the reference incline. The autoleveling device subsequently compares measured inclines to the reference incline, set after the incline adjustment. If the support apparatus deviates from the reference incline beyond a threshold of deviation, the autoleveling device processor will direct the controller to enable the appropriate lift mechanism (head or foot) to counter the deviation and correct the incline. Upon re-adjustment of the incline by a user, a new reference incline is set to which subsequent incline measurements will be compared. Thereby, the autoleveling device described above corrects deviations in the inclination of a support apparatus when the desired incline of the support apparatus is set other than horizontally.

### Autoleveling System, Maintenance of Apparatus Conformation

In some embodiments, a system of the invention comprises and autoleveling system and a support apparatus (e.g., hospital bed). The support apparatus (e.g., hospital bed) comprises multiple actuatable segments, each of which can be raised and lowered separately to provide alternate confirmations. For example, the separately actuatable sections of a hospital bed can be adjusted to place a subject occupying the bed in a lithotomy position, Fowler position, etc. The autoleveling system comprises multiple inclinometers. An autoleveling system inclinometer is configured to measure the incline of each actuatable segment of the support apparatus. A configuration is selected by a user (e.g., lithotomy position, Fowler position, etc.), and the appropriate lift mechanisms are enabled by the controller to place the apparatus in the selected position. Following extension of the appropriate lifts, and placement of the support apparatus in the selected configuration (e.g., lithotomy position, Fowler position, etc.), the autoleveling system sets the newly adjusted slopes, as measured by the inclinometers, for each actuatable segment as the reference inclines for the respective segments. Depending upon the autoleveling system and/or the mode selected, the reference inclines are set automatically upon completion of the reconfiguration, or a user depresses a level-set button to set the reference inclines. The autoleveling system subsequently compares inclines measured at each inclinometer to the respective reference inclines, as set after the incline reconfiguration. If a segment of the support apparatus deviates from its reference incline beyond a threshold of deviation, the processor of the autoleveling system will direct the controller to enable the appropriate lift mechanism to counter the deviation and correct the incline. Upon subsequent reconfiguration of the apparatus by a user, new reference inclines are set, to which subsequent incline measurements will be compared. Thereby, the autoleveling system described above corrects deviations in the conformation of a support apparatus. Such deviations may be due to uneven loads of changes in load on the support apparatus. Deviations may also arise when a user changes the height of a support apparatus in a given confirmation.

Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

What is claimed is:

1. A device comprising a position feedback device, processor, and integration circuitry configured for integration with control circuitry of a support apparatus; wherein said device detects deviations in position of said support apparatus and directs a lift mechanism of said support apparatus to correct a deviation.

2. The device of claim 1, wherein said position feedback device comprises an inclinometer.

3. The device of claim 1, wherein said integration circuitry is configured for universal integration into control circuitry of a support apparatus.

4. The device of claim 1, wherein said lift mechanism comprises one or more actuators.

5. The device of claim 1, wherein said device is integrated into said control circuitry between the control unit and lift mechanism of said support apparatus.

6. The device of claim 1, wherein deviations in the position of said support apparatus comprises deviations in incline of said support apparatus.

7. The device of claim 6, wherein said deviations in incline comprise deviations between a measured incline and a reference incline.

8. The device of claim 7, wherein said measured incline is measured by said position feedback device.

9. The device of claim 8, wherein said reference incline is set based on an absolute reference incline, instructions from said support apparatus, or user input.

10. The device of claim 1, wherein said device directs said lift mechanism to correct the incline of said support apparatus when the deviation in incline exceeds a programmed threshold of deviation.

11. A method of autoleveling a support apparatus comprising
(a) providing:
(i) a support apparatus, wherein said support apparatus comprises:
(A) a support surface;
(B) a position adjustment system comprising: two or more actuator-driven lift mechanisms, control unit, and control circuitry connecting said control unit to said actuator driven lift mechanisms; and
(ii) an autoleveling device, wherein said autoleveling device comprises an inclinometer, processor, and integration circuitry;
(b) attaching said autoleveling device to said support apparatus, wherein said inclinometer detects the degree of inclination of said support surface;
(c) integrating the integration circuitry of said autoleveling device into the control circuitry of said support apparatus;
(d) detecting the degree of inclination of said support surface of said support apparatus;
(e) comparing the detected degree of inclination of said support surface to a reference inclination; and
(f) providing means for directing said position adjustment system, wherein such means adjusts the height of one or more actuator-driven lift mechanisms to correct any deviation between said detected degree of inclination and said reference inclination.

12. The method of claim 11, wherein reference inclination is set manually by a user by engaging a level-set element when said support surface is at said reference inclination.

13. The method of claim 11, wherein following user-initiated adjustment of the inclination of said support surface, said reference inclination is automatically set to the newly achieved incline.

14. The method of claim 11, wherein said reference inclination is based on an absolute inclination.

15. The method of claim 11, wherein steps (d)-(f) are performed following a user-initiated change in the height of said support surface.

16. The method of claim 11, wherein steps (d)-(e) are performed periodically or continuously.

17. The method of claim 16, wherein step (f) is performed when a deviation is detected between said detected degree of inclination and said reference inclination.

18. A method of retrofitting a support apparatus with autoleveling functionality comprising:
(a) providing:
(i) a support apparatus, wherein said support apparatus comprises:
(A) a support surface;
(B) a position adjustment system comprising: two or more actuator-driven lift mechanisms, control unit, and control circuitry connecting said control unit to said actuator driven lift mechanisms; and
(ii) an autoleveling device, wherein said autoleveling device comprises an inclinometer, processor, and integration circuitry;
(b) attaching said autoleveling device to said support apparatus;
(c) integrating the integration circuitry of said autoleveling device into the control circuitry of said support apparatus, thereby integrating said autoleveling device into the position adjustment system of said support apparatus, wherein the processor of said integrated autoleveling device is configured to:
(i) receive control instructions from said control unit to said actuator-driven lift mechanisms;
(ii) set a reference inclination based on said control instructions, user input, and/or an absolute reference;
(iii) detect degree of inclination of said support surface of said support apparatus;
(iii) compare the detected degree of inclination of said support surface to said reference inclination; and
(iv) direct said position adjustment system to adjust the height of one or more actuator-driven lift mechanisms to correct any deviation between said detected degree of inclination and said reference inclination.
